(19) United States
(12) Patent Application Publication
(10) Pub. No.: US 2010/0045622 A1
(43) Pub. Date: Feb. 25, 2010

(54) ELECTRO-OPTICAL DEVICE, ELECTRONIC APPARATUS, AND METHOD OF DETECTING POSITION OF DIRECTING OBJECT

(75) Inventor: Taketo CHINO, Hokuto-shi (JP)

Correspondence Address: LOWE HAUPTMAN HAM & BERNER, LLP, 1700 DIAGONAL ROAD, SUITE 300, ALEXANDRIA, VA, 22314, US

(73) Assignee: SEIKO EPSON CORPORATION, Tokyo (JP)

(21) Appl. No.: 12/533,352

(22) Filed: Jul. 31, 2009

(30) Foreign Application Priority Data
Aug. 22, 2008 (JP) 2008-213636

(51) Int. Cl. G06F 3/041

(52) U.S. Cl. 345/173

(57) ABSTRACT

An electro-optical device includes an electro-optical element that includes a first electrode, a second electrode, and an electro-optical material pinched by the first and second electrodes of which the optical characteristic is changed in accordance with supply of a predetermined electric potential, a position detecting unit that detects a position of an object, which is brought into contact with an image displaying surface that displays an image configured by the electro-optical element, on the image displaying surface, and a physical amount measuring unit that is included in the position detecting unit and measures a predetermined physical amount of the whole or a part of the image displaying surface for a case where the object is brought into contact with the image displaying surface. The position detecting unit detects the position of the object on the image displaying surface based on the measurement result of the physical amount measured by the physical amount measuring unit and based on the measurement result from which the measurement result measured by the physical amount measuring unit at an inversion time of the polarity of an electric potential difference between the first electrode and the second electrode is excluded.

### BACKGROUND

1. Technical Field

The present invention relates to an electro-optical device such as a liquid crystal display device, an electronic apparatus, and a method of detecting the position of a directing object.

2. Related Art

Recently, the so-called touch panels have been provided generally. The touch panels are devices that can deliver user's intention or a user's direction to the devices through detecting the contact position of a user's finger or the like on an image displaying surface. By allowing an intuitive operation, such touch panels have an extremely user-friendly feature. Thus, the touch panels have been widely used as constituent elements of ticket-vending machines, bank ATMs, car navigation systems, and the like.

Such a touch panel commonly has an integrated relationship with an electro-optical device that has an electro-optical element of which the optical characteristics are changed in accordance with appropriate supply of an electric potential or a current that is received by a liquid crystal display device or the like. The electro-optical device is responsible for the function of displaying the image for the above-described image displaying surface.

As the above-described touch panel or the electro-optical device, for example, a device disclosed in JP-A-2004-318819 has been known.

However, in the liquid crystal display devices, so-called polarity inversion driving is performed. Here, the polarity inversion driving represents a driving method for inverting the polarity of a voltage applied to a liquid crystal, for example, for each “frame period” that is a unit time for displaying one screen of an image. For example, when the electric potential of a first electrode that is one electrode to pinch the liquid crystal is set to be higher than that of a second electrode that is the other electrode in the (2p+1)-th frame period (here, p=0, 1, 2, . . . ), the electric potentials of the first and second electrodes are set opposite in the (2p)-th frame period.

Such polarity inversion driving is performed for preventing the occurrence of an event such as deterioration of the liquid crystal due to the application of a DC current.

However, there are following problems in combining the polarity inversion driving and the above-described touch panel.

In the polarity inversion driving, there is a time interval for when the polarity of an electric potential difference between the first and second electrodes is inverted. For example, it is the period when the electric potential of the first electrode is changed from V1 to V2 (>V1), or when the electric potential of the first electrode is changed from V2 to V1.

On the other hand, detection of the contact position on the above-described touch panel is performed by using a method of detecting a change in the light amount on a contact spot of a directing object such as a finger with respect to the light amount in other spots or the like. By this method, in order to detect the change in the light amount on the image displaying surface, the light amount for the whole or a part of the image displaying surface is monitored in accordance with a predetermined time (this may be also referred to as a type of “image reading-out”).

However, in such a case, when the above-described time for the polarity inversion is temporally overlapped in the middle of the image reading-out process, there is a problem that disturbance of a displayed image in the liquid crystal display device may occur. In addition, the disturbance of the image may lead to reading-out a light amount that is different from the light amount to be originally read out. As a result, there is a problem that the detection of the contact position may be performed incorrectly.

In addition, the above-described problem occurs more or less even when the detection of the contact position on the touch panel is performed by using a method other than the above-described method.

In the above-described JP-A-2004-318819, various ideas for “detecting the coordinates with high accuracy” in a touch panel (paragraph no. 0004 of JP-A-2004-318819) have been proposed. However, the technology (see claim 11 or paragraph no. 0092 and thereafter of JP-A-2004-318819) in which an “image pickup frame period” for picking up incident light “between consecutive display frame periods” is thought to have slight relationship with the above-described viewpoint.

However, the content of this technology is almost limited to the description above, and there is no description for the relationship between the “polarity inversion driving” and the touch panel in the technology.

### SUMMARY

An advantage of some aspects of the invention is that it provides an electro-optical device, an electronic apparatus, and a method of detecting the position of the directing object.

According to a first aspect of the invention, there is provided an electro-optical device including: an electro-optical element that includes a first electrode, a second electrode, and an electro-optical material pinched by the first and second electrodes of which the optical characteristic is changed in accordance with supply of a predetermined electric potential; a position detecting unit that detects a position of an object, which is brought into contact with an image displaying surface that displays an image configured by the electro-optical element, on the image displaying surface; and a physical amount measuring unit that is included in the position detecting unit and measures a predetermined physical amount of the whole or a part of the image displaying surface for a case where the object is brought into contact with the image displaying surface. The position detecting unit detects the position of the object on the image displaying surface based on the measurement result of the physical amount measured by the physical amount measuring unit and based on the measurement result from which the measurement result measured by the physical amount measuring unit at the inversion time of the polarity of the electric potential difference between the first electrode and the second electrode is excluded.

According to the above-described electro-optical device, the touch panel as described above is configured. When there is a plurality of the electro-optical elements, image display on the image displaying surface is performed very appropriately by the plurality of the electro-optical elements. In addition, the position of an object, such as a finger, that is brought into contact with an image element such as a button, a switch, an icon, or the like that is displayed on the image displaying surface is detected in cooperation of the position detecting unit and the physical amount measuring unit that is included in the position detecting unit. For example according to an embodiment of the invention, particularly the “light amount value” as in the above-described example may correspond to the “physical amount”. In addition, the “amount of accumulated electric charge” that is accumulated in a capacitor arranged for each electro-optical element or a “current value” that is generated based on the amount of the accumulated electric charges may correspond to the “physical amount”. In the former case, the “position detecting unit” and the “physical amount measuring unit”, for example, include various optical sensors. On the other hand, in the latter case, the “position detecting unit” and the “physical amount measuring unit” include the above-described capacitors or the like. As a detailed form of the “physical amount” or detailed forms of the “position detecting unit” and the “physical amount measuring unit”, various forms other than that described above can be considered.

In addition, according to the above-described electro-optical device, particularly, detection of the position of an object on the image displaying surface is performed based on the measurement result from which the measurement result measured at the inversion time by the physical amount measuring unit is excluded. Accordingly, as in the above-described example, image reading that is temporally overlapped with the inversion time is not performed or the detection of the position on the basis of the result of image reading is not performed even for a case where the image reading temporally overlapped with the inversion time is performed.

According to the above-described electro-optical device, the possibility of occurrence of disturbance of an image is decreased much, and detection of the contact position of an object is performed with high accuracy.

In addition, the “electro-optical device” according to this aspect includes the configuration that includes the touch panel as described above, and accordingly, if more precisely stated, the “electro-optical device” may be also paraphrased with a “touch panel-attached image displaying device”.

In the above-described electro-optical device, the physical amount measuring unit may be configured to measure the physical amount only between two inversion times that are temporally adjacent to each other.

In such a case, the measurement of the physical amount is not originally performed at the inversion time, and accordingly, the physical amount is not supplied to the position detecting unit. Accordingly, in such a case, the advantages of the above-described electro-optical device are acquired more effectively.

In addition, it is apparent in the context that the “two” mentioned here is a term to be read in association with the “that are temporally adjacent to each other”. Accordingly, “two inversion times” described here typically represent “all the inversion times” for a case where the above-described electro-optical device performs the polarity inversion driving (if stated more formally, “two inversion times that are temporally adjacent to each other” are two consecutive inversion times arbitrarily selected from among all the inversion times).

This also applies to the term of “two inversion time” (or “n inversion times”) that are used in other descriptions of an embodiment of the invention.

In addition, in the above-described electro-optical device, it may be configured that the physical amount measuring unit measures the physical amount between two inversion times that are temporally adjacent to each other and at the two inversion times, and the position detecting unit detects the position of the object on the image displaying surface by ignoring the result measured at the two inversion times by the physical amount measuring unit.

In such a case, measurement of the physical amount is performed at the inversion times. However, the position detecting unit ignores the result of detection. Accordingly, in this case, the advantages of the above-described electro-optical device are acquired more effectively.

In addition, in the above-described electro-optical device, it may be configured that the physical amount measuring unit measures the physical amount for each one of a plurality of measurement areas that partitions the physical displaying surface, and the physical amount measuring unit measures the physical amount at a time other than the inversion times for the measurement area corresponding to the physical amount that is detected at the inversion time, again.

In such a case, not only does the position detecting unit ignore the result of measurement of the physical amount that is measured at the inversion times but also the physical amount measuring unit is configured to measure the physical amount of the measurement area at a time other than the inversion times again instead of the physical amount measured at the inversion times and to supply the re-measured physical amount to the position detecting unit. Accordingly, in such a case, the advantages of the above-described electro-optical device are acquired more effectively.

In addition, in the above-described electro-optical device, it may be configured that a plurality of the electro-optical elements exists and is aligned along the matrix-shaped array, the physical amount measuring unit includes a plurality of physical amount measuring elements corresponding to a predetermined number of the electro-optical elements and signal lines that is used for reading out the measurement results of the physical amount measuring elements, and the reading-out of the physical amounts by using the signal lines is performed for “1/(n−1)” physical amount measuring elements among the physical amount measuring elements corresponding to a specific row of the matrix-shaped array after the m-th inversion time (here, m=1, 2, . . . , n−1) among n inversion times (here, n is a positive integer) that are temporally continuous.

In such a case, first, the electro-optical elements are aligned along the matrix-shaped array, and the physical amount measuring elements are in correspondence with each predetermined number of the electro-optical elements. Thus, typically, the form in which the physical amount measuring elements are aligned along a predetermined matrix-shaped array following the matrix-shaped array of the electro-optical elements can be considered easily. In that case, for example, the portion of the signal line is arranged along a row or a column that can be conceived for the physical amount measuring elements and for each row or column. In addition, the other portion of the signal line has one end being connected to a circuit (a circuit that is needed for appropriately processing a plurality of signals to be transmitted by using a plurality of signal lines or the like) or the like that is arranged in a part of the signal line and the other end being connected to a circuit or the like that is appropriate to a final process for the signal.

However, the signal line mentioned in this case has parasitic capacitance and the like. Accordingly, it is relatively difficult to perform a read-out (particularly, an “accurate” read-out) of the physical amount in a relatively short time period. The reason is that the electric potential of the signal line and the like is gradually increased in accordance with the elapse of time from the starting time point of the read-out due to existence of the parasitic capacitance and the like.

In this case, such a problem is solved more assuredly. The reason is that, in this case, measurement of the physical amount is performed only for a part of the physical amount measuring elements in each row, and accordingly, the measurement time can be set to be relatively long. Accordingly, the possibility that the electric potential or the like of the signal line reaches to a stable state is increased (such an advantage can be more clearly recognized when a case where measurement for all the physical amount measuring elements is performed altogether at a same time is considered).

As described above, in such a case, an accurate physical amount on which the actual state is well reflected can be acquired.

In addition, there may be a concrete form in which the physical amount measuring elements cannot be easily stated to be aligned along the “matrix-shaped array”, differently from the above-described example, even for a case where the electro-optical elements are aligned along the “matrix-shaped array”. However, this case is not intended to aggressively exclude such a form. Even in such a case, in order to read out the measurement result by using the physical amount measuring elements, existence of the “signal line” in some meanings is required. Accordingly, the above-described operations and advantages can be realized based on the configuration of this form without any change.

In addition, in the above-described configuration, for example, when two inversion times are considered (in other words, n=2), read-out for a half of the physical amount measuring elements is performed after the first inversion time. After the second inversion time, it is preferable that read-out for the “remaining” half of the physical amount measuring elements is performed. Accordingly, a read-out for all the physical amount measuring elements in the row can be performed efficiently. A more detailed form for this point will be described in the second embodiment described below, as well.

In addition, in the above-described electro-optical device, in the case where an area in which the image is not displayed is included in a portion of the image displaying surface, the physical amount measuring unit may be configured to measure the physical amount at a time when the electro-optical element corresponding to the area is driven.

In such a case, the physical amount is measured at a time when the electro-optical elements corresponding to an area, in which an image is not displayed, are driven. Accordingly, the measurement of the physical amount can be performed by avoiding the inversion times. The reason is that the “inversion of the polarity” according to an embodiment of the invention, normally, does not occur at the above-described time.

Accordingly, in this case, the advantages of the above-described electro-optical device can be acquired more effectively. In addition, an advantage that all the measurement results of physical amounts needed for detection of the position can be acquired in a speedier manner can be acquired.

In addition, in the above-described electro-optical device, it may be configured that at least one of the first electrode and the second electrode is aligned along a matrix-shaped array, and the inversion of the polarity of the electric potential is performed by using a row or a column of the matrix-shaped array as one unit.

Such a case can be applied to an electro-optical device that performs so-called line inversion driving.

According to a second aspect of the invention, there is provided an electronic apparatus that includes the above-described electro-optical device.

The above-described electronic apparatus is configured to include the above-described various electro-optical devices. In other words, the position of an object is detected based on the measurement result from which the measurement result of the physical amount measured at the inversion time is excluded. Accordingly, a high-quality image can be displayed, and detection of the position can be performed with higher accuracy.

According to a third aspect of the invention, there is provided a method of detecting the position of a directing object for detecting the position of the object, which directs a spot on an image displaying surface displaying an image, on the image displaying surface. The method includes: applying a predetermined electric potential difference between a first electrode and a second electrode for changing the optical characteristics of an electro-optical material that is pinched between the first and second electrodes that configures an electro-optical element forming the image; measuring a predetermined physical amount of the whole or a part of the image displaying surface for a case where the object is brought into contact with the image displaying surface; and detecting the position of the object, which is brought into contact with the image displaying surface, on the image displaying surface based on the result of the physical amount measurement in the predetermined physical amount measuring. The applying of the predetermined electric potential difference includes inverting the polarity of the electric potential difference between the first electrode and the second electrode, and the detecting of the position of the object includes detecting the position of the object on the image displaying surface based on the measurement result from which the result measured at an inversion time of the polarity by the physical amount measuring unit.

According to the above-described method, the operations and advantages that are not essentially different from those implemented by the above-described electro-optical device are implemented. In addition, the above-described method provides an operating method that is very appropriate for operating the above-described optical device.

In the above-described method of detecting the position of the directing object, the measuring of the predetermined physical amount may be configured to include measuring the physical amount only between two inversion times that are temporally adjacent to each other.

In addition, in the above-described method of detecting the position of the directing object, it may be configured that the measuring of the predetermined physical amount includes measuring the physical amount between two inversion times that are temporally adjacent to each other and at the two inversion times, and, in the detecting of the position of the object, the position of the object on the image displaying surface is detected by ignoring the measurement result measured at the two inversion times by the physical amount measuring unit.

In addition, in the above-described method of detecting the position of a directing object, it may be configured that the measuring of the predetermined physical amount includes measuring the physical amount for each one of a plurality of measurement areas that partitions the image displaying surface, and the measuring of the predetermined physical amount includes measuring the physical amount at a time other than the inversion times for the measurement area corresponding to the physical amount that is detected at the inversion time, again.

In addition, in the above-described method of detecting the position of a directing object, it may be configured that a plurality of the electro-optical elements exists and is aligned along a matrix-shaped array, the measuring of the physical amount is performed by using a plurality of physical amount measuring elements corresponding to a predetermined number of the electro-optical elements and signal lines that are used for reading out the measurement results measured by the physical amount measuring elements, and the reading-out the physical amounts by using the signal lines is performed for “1/(n−1)” physical amount measuring elements among the physical amount measuring elements corresponding to a specific row of the matrix-shaped array after the m-th inversion time (here, m=1, 2, . . . , n−1) among n inversion times (here, n is a positive integer) that are temporally continuous.

In addition, in the above-described method of detecting the position of a directing object, in a case where an area in which the image is not displayed is included in a portion of the image displaying surface, the measuring of the predetermined physical amount is configured to be performed at a time when the electro-optical element corresponding to the area is driven.

In addition, in the above-described method of detecting the position of a directing object, it may be configured that at least one between the first electrode and the second electrode is aligned along a matrix-shaped array, and the inverting of the polarity of the electric potential is performed by using a row or a column of the matrix-shaped array as one unit.

According to the above-described various forms of the above-described method, the operations and advantages that are not essentially different from those implemented by the various forms of the above-described electro-optical device are implemented.

### BRIEF DESCRIPTION OF THE DRAWINGS

The invention will be described with reference to the accompanying drawings, wherein like numbers reference like elements.

FIG. 1 is a block diagram showing the entire configuration of an electro-optical device according to a first embodiment of the invention.

FIG. 2 is an equivalent circuit diagram of a liquid crystal element and a light amount detecting element that configure the electro-optical device shown in FIG. 1.

FIG. 3 is a timing chart showing inversion of the polarity of an opposing electrode and an appearance of image reading-out between inversion times.

FIG. 4 is a flowchart relating to a reference image acquiring process (initialization process).

FIG. 5 is a flowchart relating to a process for detecting the position of an object on an image displaying surface.

FIG. 6 is a diagram showing an appearance of the user's finger's contact on the image displaying surface, an appearance of a shade formed in accordance with the contact, and the like.

FIG. 7 is a flowchart showing a more detailed content of a target image reading-out process (Step S201) shown in FIG. 5.

FIG. 8 is a diagram showing an example of arrangement of a liquid crystal element and a light amount detecting element according to a second embodiment of the invention.

FIG. 9 is a diagram showing the circuit configuration for reading out light amount data from the light amount detecting element shown in FIG. 8.

FIG. 10 is a flowchart showing the content of a target image reading-out process relating to the second embodiment.

FIG. 11 is a diagram corresponding to FIG. 3 and is a timing chart particularly showing an example of a case where the waveform of a read-out signal gradually moves upwards in accordance with the elapse of time.

FIG. 12 is a flowchart showing the content of a target image reading-out process according to a third embodiment of the invention.

FIG. 13 is a flowchart showing the content of a target image reading-out process according to a modified example of an embodiment of the invention.

FIG. 14 is a perspective view showing an electronic apparatus (personal computer) according to an embodiment of the invention.

FIG. 15 is a perspective view showing an electronic apparatus (cellular phone) according to an embodiment of the invention.

FIG. 16 is a perspective view showing an electronic apparatus (personal digital assistants) according to an embodiment of the invention.

### DESCRIPTION OF EXEMPLARY EMBODIMENTS

### First Embodiment

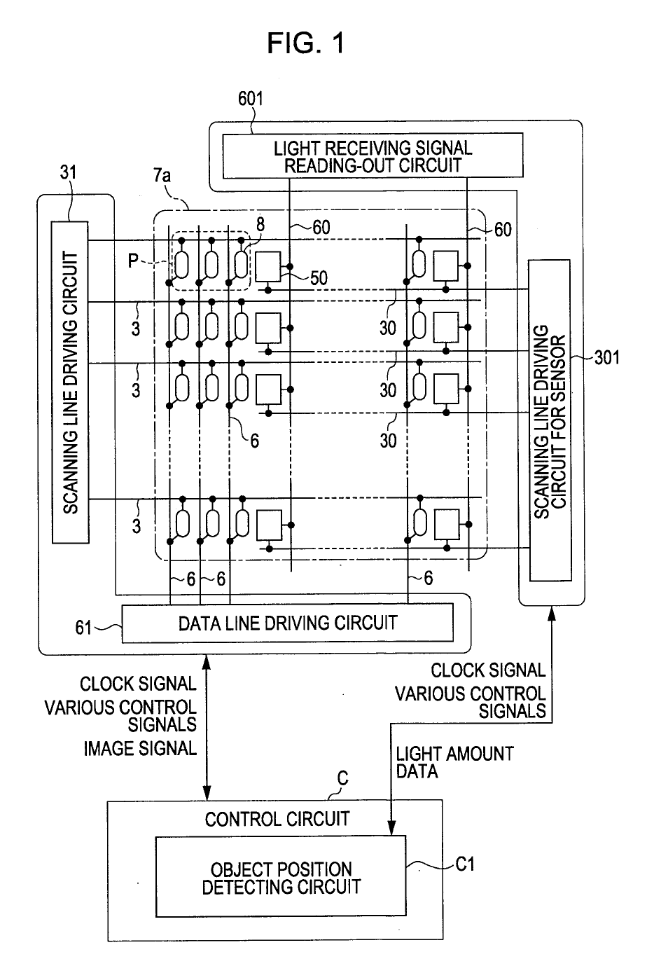

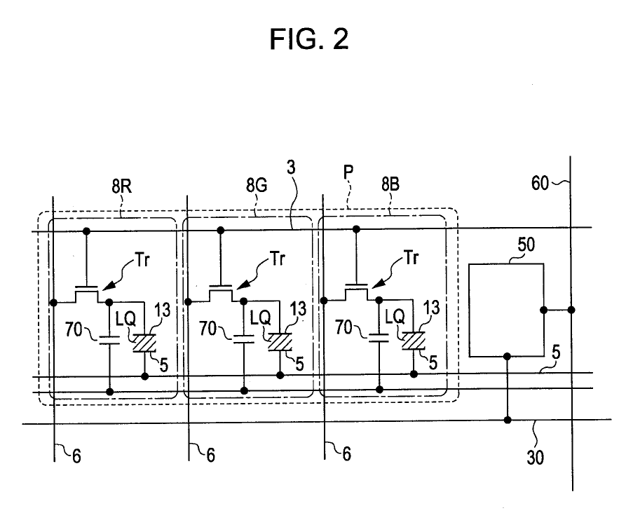

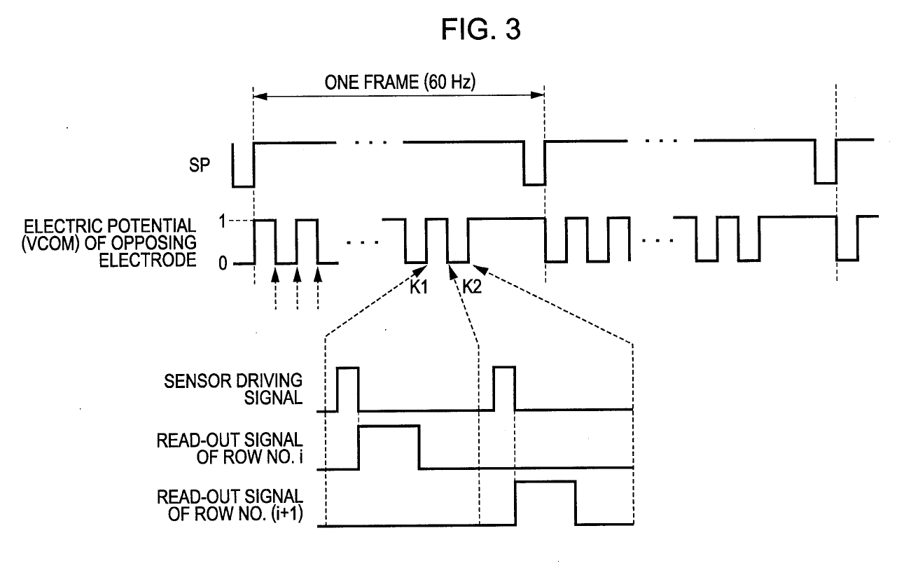

Hereinafter, a first embodiment of the invention will be described with reference to FIGS. 1 and 2. In diagrams referred to as below in addition to the above-described FIGS. 1 and 2, the ratios of the sizes of parts, including the sizes or the scales of curves in timing charts shown in FIGS. 3 and 11, may be represented to be appropriately different from the ratios of the actual sizes thereof.

An electro-optical device 1 according to the first embodiment, as shown in FIG. 1, includes liquid crystal elements (electro-optical elements) 8, scanning lines 3, data lines 6, a scanning line driving circuit 31, a data line driving circuit 61, and the like.

Among these, the liquid crystal element 8, as shown in FIG. 2 in detail, is configured by a pixel electrode 13, an opposing electrode 5, a storage capacitor 70, and a switching transistor Tr.

The pixel electrodes 13 are aligned in a matrix-shaped array on a component substrate not shown in the figure (see FIG. 1). Each 1×1 pixel electrode 13, for example, has a rectangular shape, an oval shape, or the like in the plan view.

Among the pixel electrodes 13 arranged in the matrix shape as described above, the pixel electrode 13 aligned in each row is commonly connected to the scanning line 3 disposed in each row. In addition, the pixel electrode 13 aligned in each column is commonly connected to the data line 6 disposed in each column (see FIG. 2 and the like). The switching transistor Tr is arranged among the scanning line 3, the data line 6, and the pixel electrode 13. This switching transistor Tr transits between the ON state and the OFF state in accordance with the selection signal that is supplied to the scanning line 3. When the switching transistor Tr is in the ON state, the pixel electrode 13 receives supply of the image signal that is supplied through the data line 6.

In addition, the storage capacitor 70 shown in FIG. 2 accumulates electric charges corresponding to the level of the image signal. In addition, the existence, the content, the supply time, and the like of an image signal to be supplied to the data line 6 are determined by the data line driving circuit 61. Similarly, the supply time and the like of a selection signal to be supplied to the scanning line 3 are determined by the scanning line driving circuit 31.

The opposing electrode 5 has a rectangular form so as to cover the entire area that forms the pixel electrode 13 (in other words, this opposing electrode 5 has a shape so as to cover the entire surface of the component substrate). In other words, the opposing electrode 5 serves as one electrode that is common to all the pixel electrodes 13. This opposing electrode 5, for example, is formed on the opposing substrate that faces the component substrate on which the pixel electrodes 13 are formed.

In addition, a liquid crystal layer LQ is pinched between the opposing electrode 5 and the pixel electrode 13. As the liquid crystal layer LQ, a liquid crystal that can respond at a high speed, for example, an OCB (optically compensated bend) mode liquid crystal or the like is used very appropriately.

Under the above-described configuration, the aligning state of the liquid crystal layer LQ changes in accordance with an electric potential difference applied between the pixel electrodes 13 and the opposing electrode 5. Accordingly, a ratio (transmittance) of the amount of light transmitted to the observation side to light emitted from an illumination device not shown in the figure is controlled for each pixel electrode 13.

Accordingly, an image of the desired meaning and contents can be displayed in the electro-optical device 1. A reference sign “7a” shown in FIG. 1 represents a schematic area in which the image to be displayed. Hereinafter, this area will be referred to as an “image displaying surface 7a” (the size of the image displaying surface 7a may be regarded to roughly coincide with an area in which all the pixel electrodes 13 are formed or an area in which the opposing electrode 5 is formed. In addition, in this first embodiment, the “image displaying surface 7a”, more practically, is a surface on which a physical contact of the user's finger or the like is allowed. In addition, “surfaces” of the opposing substrate that is a glass plate on which the opposing electrode 5 is formed, the polarizing plate that is overlapped with the opposing substrate, the protection glass plate that is additionally overlapped with the polarizing plate, the appropriate protection film that is formed on the protection glass plate, and the like correspond to the above-described image displaying surface in a more concrete meaning).

In addition, according to the first embodiment, particularly, the polarity of the electric potential applied between the pixel electrode 13 and the opposing electrode 5 is inverted for each constant period. This point will be described later.

In addition, particularly, the electro-optical device 1 according to the first embodiment, as shown in FIG. 1, includes a light amount detecting element (physical amount measuring element) 50, a scanning line driving circuit 301 for the sensor, and a light receiving signal reading-out circuit 601.

The light amount detecting element 50 measures the existence and the degree of light emitted from the liquid crystal element 8 or the existence and the degree of light incident from the outside of the electro-optical device 1. In particular, for example, a photo diode or the like is used very appropriately as the light amount detecting element 50. This light amount detecting element 50, as shown in FIG. 1 or FIG. 2, is arranged at the ratio of one to three liquid crystal elements 8 described above. As described above, since the pixel electrodes 13 are aligned along the matrix shaped array (as is apparent from the description as above, this may be paraphrased that the liquid crystal elements 8 are aligned along the matrix shaped array), the light amount detecting elements 50 are also aligned along the matrix-shaped array that is the same type of the matrix-shaped array of the pixel electrodes 13 and is slightly different from the matrix-shaped array of the pixel electrodes 13 (see FIG. 1).

According to the first embodiment, as described above, the so-called unitary configuration is formed by three liquid crystal elements 8 and one light amount detecting element 50. In addition, the three liquid crystal elements 8 may be used for colored light emission of red, green and blue, for example, by arranging color filters not shown in the figure. In addition, reference signs “8R”, “8G”, and “8B” shown in FIG. 2 represent such situation (in addition, the reference sign “8” in description of the first embodiment and the drawings is used as the reference sign for collectively representing all the reference signs “8R”, “8G”, and “8B”). By handling the set (see a reference sign P shown in FIGS. 1 and 2) of the liquid crystal elements 8 corresponding to such three colors as one unit, display of the color image can be realized in the first embodiment.

The above-described light amount detecting element 50, as shown in FIGS. 1 and 2, is connected to the scanning line 30 for the sensor that extends along the line direction of the matrix-shaped array. The scanning line driving circuit 301 for the sensor receives the driving times of the light amount detecting elements 50 located in each row for the row through the scanning line 30 for the sensor. In addition, the light amount detecting element 50 is connected to a signal line 60 for the sensor that extends along the column direction of the matrix-shaped array. The amount of light that is measured by the light amount detecting element 50 is supplied to the light receiving signal reading-out circuit 601 through the signal line 60 for the sensor.

In addition, the rectangular box (that is, the “light amount detecting element 50”) shown in FIG. 1 and the like to which a reference sign 50 is assigned represents that the rectangular box may include other necessary circuits such as a circuit used for appropriately shaping the signal acquired by converting the detected amount of light.

Finally, the control circuit C controls the entire operations of the electro-optical device 1 in a harmonic manner. In particular, for example, as shown in FIG. 1, the control circuit C supplies a clock signal and various control signals to the scanning line driving circuit 31, the data line driving circuit 61, the scanning line driving circuit 301 for the sensor, and the light receiving signal reading-out circuit 601. In addition, the control circuit C supplies the above-described image signal to the data line driving circuit 61 and receives supply of the light amount data that is read out from the light receiving signal reading-out circuit 601.

Accordingly, the control circuit C selects the liquid crystal elements 8 of each row in a line sequential manner, for example, through the scanning line driving circuit 31 and performs supply of an image signal for the selected liquid crystal elements 8 at appropriate time through the data line driving circuit 61 and the like.

Particularly according to the first embodiment, the control circuit C controls the polarity inversion driving of the electric potential applied between the pixel electrode 13 and the opposing electrode 5. In addition, inside the control circuit C, the object position detecting circuit C1 is built. This object position detecting circuit C1 detects the position of the object such as the user's finger, the end of a pen, or the like, which is brought into contact with the above-described image displaying surface 7a, on the image displaying surface 7a based on the content of the light amount data. The content of the above-described process will be described again later in detail.

In addition, an embodied example of the “position detecting unit” according to an embodiment of the invention is configured by the above-described light amount detecting element 50 or a configuration (that is, the light receiving signal reading-out circuit 601 and the like) for reading out the result of measurement of the light amount by driving the light amount detecting element 50, the image displaying surface 7a, the control circuit C, and the like.

Hereinafter, the action of the electro-optical device 1 according to the first embodiment described above, that is, an example of the operation of the electro-optical device 1 will be described with reference to FIGS. 3 to 6 in addition to FIGS. 1 and 2 referred to as above.

First, before a core content will be described, the polarity inversion driving relating to the electric potential difference between the pixel electrode 13 and the opposing electrode 5 will be described. According to the first embodiment, the control circuit C inverts the polarity of the electric potential difference between the pixel electrode 13 and the opposing electrode 5 for each predetermined period.

The “predetermined period” described here, for example, is determined based on a period in which one of the scanning lines 3 is selected in accordance with the selection signal and the like. A detailed description will be followed as below. First, start of one frame period, as shown in FIG. 3, is represented by the start pulse SP. Accordingly, thereafter, the scanning lines 3 are sequentially selected one after another, for example, from the upper side in FIG. 1. In such a case, the electric potentials of the electrodes 13 and 5, for example, are set such that the electric potential of the pixel electrode 13 is higher than that of the opposing electrode 5 for the case where the first one scanning line 3 is selected, and the electric potential of the pixel electrode 13 is lower than that of the opposing electrode 5 for the case where the next one scanning line 3 is selected. In short, in such a case, when the odd scanning line 3 is selected, the electric potential of the pixel electrode 13 is higher than that of the opposing electrode 5. On the other hand, when an even scanning line 3 is selected, the electric potential of the opposing electrode 5 is higher than that of the pixel electrode 13.

At any rate, when such polarity inversion driving is performed, progress of the deterioration of the liquid crystal layer LQ can be prevented as much as it can be. In the first embodiment, a particularly notable point is that, the “inversion time” of the electric potential is generated necessarily as shown in points (for example, see reference signs “K1” and “K2”) of broken arrows assigned to the timing chart located on the second level from the upper side in FIG. 3, when such polarity inversion driving is performed (this point will be described again later).

In addition, the timing chart located on the second level from the upper side in FIG. 3 depicts only the appearance of inversion or transition of the electric potential VCOM (hereinafter, this will be referred to as a “common electric potential VCOM”) of the opposing electrode 5. The electric potential of the pixel electrode 13 takes an appropriate electric potential in accordance with the inversion of the common electric potential VCOM (in addition, it is apparent that the electric potential of the pixel electrode 13 also follows the content of an image signal).

In the description above, “one frame” is used as a term that means a period from when the first scanning line 3 is selected and the image signal is supplied to each pixel electrode 13 corresponding thereto to when the last scanning line 3 is selected and the image signal is supplied to each pixel electrode 13 corresponding thereto (in such a case, one frame has an almost same meaning as a period in which an image having one unified content can be displayed on the image displaying surface 7a). The length of one frame, for a concrete example, as shown in FIG. 3, is set to “60 Hz” or the like in terms of the frequency.

On the above-described premise, according to the first embodiment, the basic process relating to detection of the position of an object on the image displaying surface 7a is performed as below.

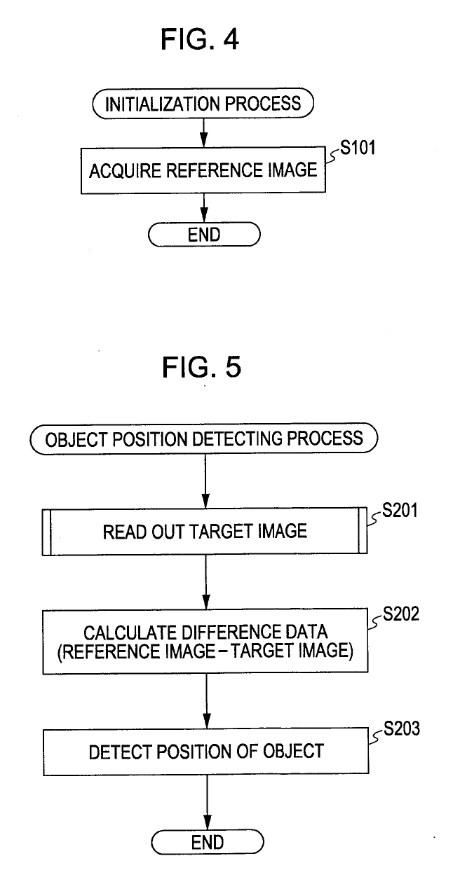

First, as shown in FIG. 4, the reference image is acquired (Step S101 shown in FIG. 4). Here, the “reference image” is the image that is acquired in advance as the comparative target of the target image to be described later and of which the entire surface is basically defined in accordance with the fixed constant amount of light. In particular, the time such as the time right after input of the power source to the electro-optical device 1 in which the user's finger or the like is scarcely brought into contact with the image displaying surface 7a is selected for performing acquisition of the reference image.

Subsequently, as shown in FIG. 5, the process for detecting the position of the object such as a finger is performed. First, this process is started by read-out of the “target image” (Step S201 shown in FIG. 5). This process for reading-out the target image includes the process that is characterized according to the first embodiment. This point will be described again later. In addition, both the process for reading-out the target image and the above-described process for acquiring the reference image are performed by using the light amount detecting element 50, the light receiving signal reading-out circuit 601, and the like that are described above.

Next, the difference data between the target image and the above-described reference image is calculated (Step S202 shown in FIG. 5). The calculation of the difference data and the process for detecting the position of an object to be described right below are performed by the above-described control circuit C or the object position detecting circuit C1. In addition, in order to perform such a processes more appropriately, a memory device that can store the read-out target image or the reference image for the predetermined time or more is arranged inside the control circuit C or the like.

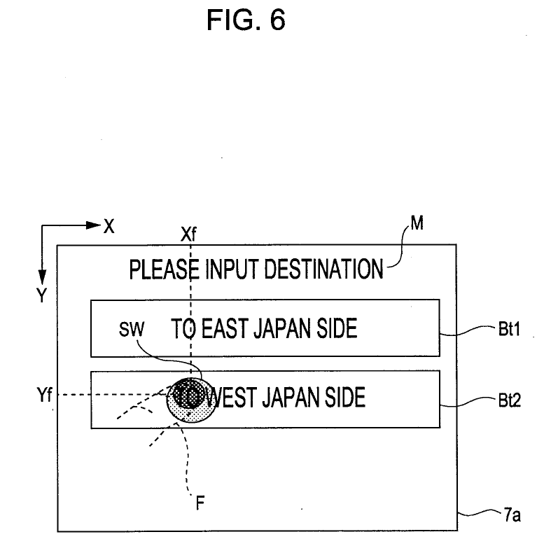

Next, the position of the object such as the user's finger or the like is detected based on the difference data (Step S203 shown in FIG. 5). Here, a more detailed content of the difference data can be visually perceived, for example, by referring to FIG. 6.

In FIG. 6, the appearance in which a user's finger F is brought into contact with one point located on the image displaying surface 7a is shown. In such a case, a shadow SW is formed in a spot with which the finger F is brought into contact. Or, light emitted from the liquid crystal element 8 is appropriately reflected on the surface of the finger F so as to be scattered. At any rate, the above-described phenomenon occurs in accordance with the contact of the finger F. Accordingly, the amount of light in the contact spot becomes different from that in areas of the other portions.

Here, the above-described reference image, for example, is prepared as an image that does not have any shadow SW shown in FIG. 6 or the like. Accordingly, the difference data described above is calculated finally by configuring an image from which only the shadow SW and the like are extracted. In addition, in such a case, it is apparent that acquisition of the position of the shadow SW or the like on the image displaying surface 7a is performed in a relatively easy manner (see reference signs “Xf” and “Yf” shown in FIG. 6).

In addition, when the process for detecting the contact position of the above-described finger F is performed, for example, as also shown in FIG. 6, image elements such as various messages M, buttons Bt1 and Bt2, and the like can be displayed appropriately on the image displaying surface 7a.

As described above, according to the electro-optical device 1 of the first embodiment, detection of the position of the finger F on the image displaying surface 7a is performed.

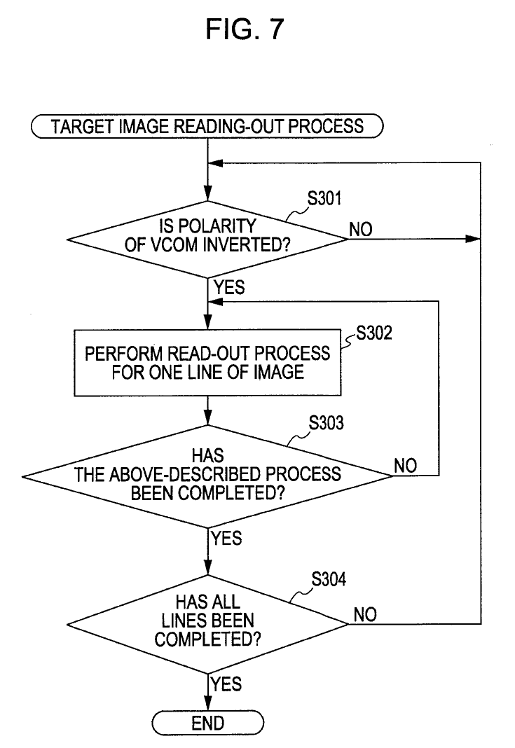

In the above-described basic process, according to the first embodiment, particularly, there is a special aspect relating to the content of the target image reading-out process (Step S201 shown in FIG. 5) shown in FIG. 5. Such process is performed as shown in FIG. 7.

First, the control circuit C determines whether there is inversion of the polarity of the common electric potential VCOM (Step S301 shown in FIG. 7). In other words, it is determined whether there is any “inversion time”, indicated in advance with reference to FIG. 3, that is represented by each point of the broken-line arrows (in addition, the broken-line arrows shown in FIG. 3, as are apparent from the drawing positions, do not indicate all the inversion times). Since an “image reading-out process” to be described right below is performed after this determination process is performed. Accordingly, the “image reading-out process” is performed at a time other than the inversion times.

Next, when there is the inversion of the polarity of the common electric potential VCOM (Step S301 shown in FIG. 7; YES), the image reading-out process for one line is performed (Step S302 shown in FIG. 7).

In other words, as shown in FIG. 3, as the scanning line driving circuit 301 for the sensor gives off a sensor driving signal for the i-th row (here, i is a positive integer not exceeding the number of rows of the liquid crystal elements 8; see FIG. 1 or FIG. 2), the light amount detecting elements 50 located in the i-th row is driven. Accordingly, the signal line 60 for the sensor receives a supply of an electric signal or light amount data (see FIG. 1) in accordance with the amount of light that is received by the light amount detecting element 50 and is appropriately converted. The light receiving signal reading-out circuit 601 reads the signal or the light amount data described above and supplies it to the control circuit C.

In such a case, Step S303 shown in FIG. 7 means that whether the read-out for all the light amount detecting elements 50 located in the i-th row is completed is monitored all the time (Steps S302 and S303 shown in FIG. 7 are processes that are performed integrally or simultaneously in a parallel manner, in such a meaning).

In addition, the example of the waveform of the read-out signal for the i-th row shown in FIG. 3 shows a representative example of the waveform of a read-out signal or light amount data that is originated from one light amount detecting element 50 (see FIG. 1) that is located in a portion in which, for example, the i-th row and any arbitrary one column intersect each other. An example of the waveform located on the lowermost side of FIG. 3, that is, the waveform of the read-out signal for the (i+1)-th row or an example of the waveform of a read-out signal shown in FIG. 11 that is to be described later in the second embodiment of the invention is the same as the above-described example of the waveform.

The above-described process is repeatedly performed until the image reading-out process for all the lines are completed (Step S304 shown in FIG. 7). In other words, for example, as shown in FIG. 3, after the inversion time K2, which follows the inversion time K1 that becomes the momentum for the read-out process for the light amount detecting element 50 located in the i-th row, occurs, a read-out process for the light amount detecting element 50 located in the (i+1)-th row is performed.

By performing the above-described process, the following advantages can be acquired in the first embodiment. According to the first embodiment, as is apparent from the description above, the read-out process for the target image that uses the light amount detecting element 50 is performed by avoiding the inversion time or performed at a time other than the inversion time.

When a case where the image reading-out process is performed at the inversion time in a temporally overlapping manner is considered, contrary to the above-described process, the inventor of the invention checked that there was high possibility of occurrence of disturbance in a displayed image. When such disturbance of the image occurs, there is a problem that the read-out light amount data may not reflect the actual state (for example, the state as shown in FIG. 6) accurately. Accordingly, there is a possibility that the above-described process for detecting the position of the object may not be performed with high accuracy.

On the other hand, according to the first embodiment, as described above, the light amount data is read out by avoiding the inversion time. Accordingly, the light amount data that is read out at the inversion time or the target image that is acquired at that moment is not used at all in the above-described difference data calculating process (Step S202 shown in FIG. 5) or the process for detecting the position of the object (Step S203 shown in FIG. 5).

As described above, according to the first embodiment, the possibility that the disturbance or the like of the image occurs is decreased much, and detection of the contact position of the object is performed with high accuracy.

### Second Embodiment

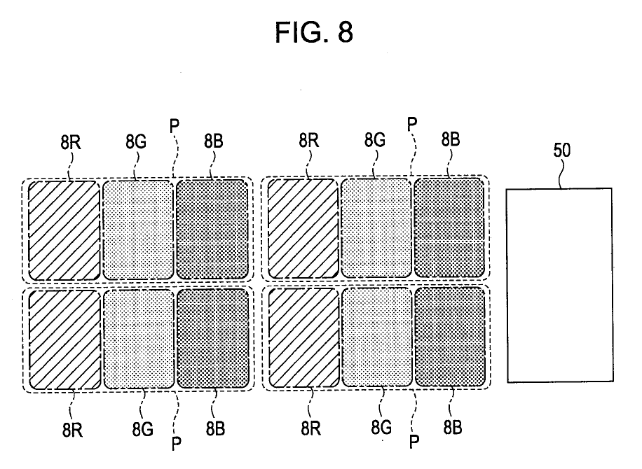

Hereinafter, the second embodiment of the invention will be described with reference to FIGS. 8 to 11. The configuration of an electro-optical device 1, the content of the basic process relating to a process for detecting the position of an object, and the like according to the second embodiment are the same as those according to the first embodiment. Thus, the description of a duplicate portion will be simplified or omitted appropriately.

First, according to the second embodiment, as shown in FIG. 8, one light amount detecting element 50 is disposed for each twelve liquid crystal elements 8. However, the aligning form of three liquid crystal elements 8 among twelve liquid crystal elements 8 that configure one set (see a reference sign P shown in FIG. 8) is the same as that of the first embodiment. The liquid crystal elements 8R, 8G, and 8B, which are used for emitting colored light of red, green and blue, are sequentially aligned from the left side in the figure. The entire twelve liquid crystal elements 8 have an arrangement form in which two sets described above are aligned in the vertical direction and two sets described above are aligned in the horizontal direction. In addition, as is apparent from the figure, the light amount detecting elements 50 are aligned along the predetermined matrix-shaped array in this case, similar to the first embodiment.

As described above, according to the second embodiment, one unitary configuration is formed by twelve liquid crystal elements 8 and one light amount detecting element 50.

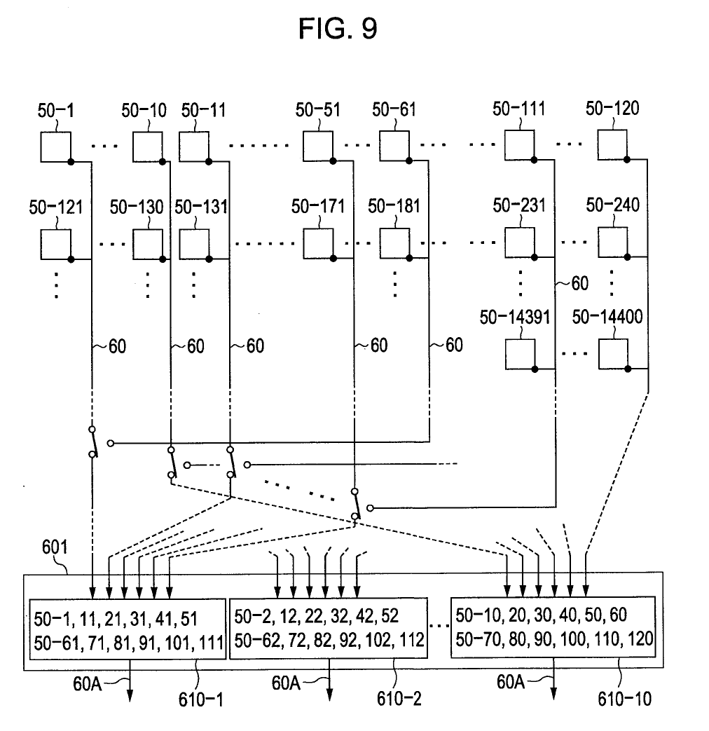

According to the second embodiment, as shown in FIG. 9, 120 unitary configurations described above are aligned in the horizontal direction in the figure, and 120 unitary configurations described above are aligned in the vertical direction (accordingly, 120×120 light amount detecting elements 50 are aligned naturally). When described in correspondence with FIG. 8, the number of the above-described set (or may be referred to as a “pixel”) that is configured by three liquid crystal elements 8 is 240 in the horizontal direction in the figure and is 240 in the vertical direction. Thus, when one liquid crystal element 8 is regarded as one unit, the number of the units is 1440×480 (however, all of them are not shown in FIG. 9).

In addition, according to the second embodiment, as shown in FIG. 9, ten multiplexers 610-1 to 610-10 are arranged inside the light receiving signal reading-out circuit 601 (compared to FIG. 1, the position of the light receiving signal reading-out circuit 601 in the figure is vertically reversed).

To this multiplexer 610, sensor signal lines 60 are connected. The form of connection of the sensor signal lines 60 is shown in the figure. An example of the form of the connection will be described here. For example, first, the sensor signal lines 60 that are connected to the light amount detecting elements 50-1, 11, 21, 31, 41, and 51 are connected to the multiplexer 610-1 located on the leftmost side in the figure. In addition, the light amount detecting elements 50-61, 71, 81, 91, 101, and 111 are connected to the multiplexer 610-1 through other sensor signal lines 60 that are connected to the sensor signal lines 60 through switches. As a result, under the configuration shown in FIG. 9, the light amount data transmitted from the light amount detecting elements 50-1, 11, 21, 31, 41, and 51 can be acquired at a time point, and the light amount data transmitted from the light amount detecting elements 50-61, 71, 81, 91, 101, and 111 can be acquired at another time point. The light amount data acquired as described above is appropriately supplied to the control circuit C from the multiplexer 610-1 through an external signal line 60A.

As shown in the figure, other multiplexers 610-2, 3 . . . 10 are configured to be the same as the multiplexer 610-1.

Accordingly, as a result, under the configuration shown in FIG. 9, like in the case where the light amount data originated from the light amount detecting elements 50-1, 2, . . . , 60 can be acquired at a time point, and the light amount data originated from the light amount detecting elements 50-61, 62, . . . , 120 can be acquired at another time point, the light amount data originated from a half of the light amount detecting elements 50 among the light amount detecting elements 50 that are located on one line can be acquired at any one time point.

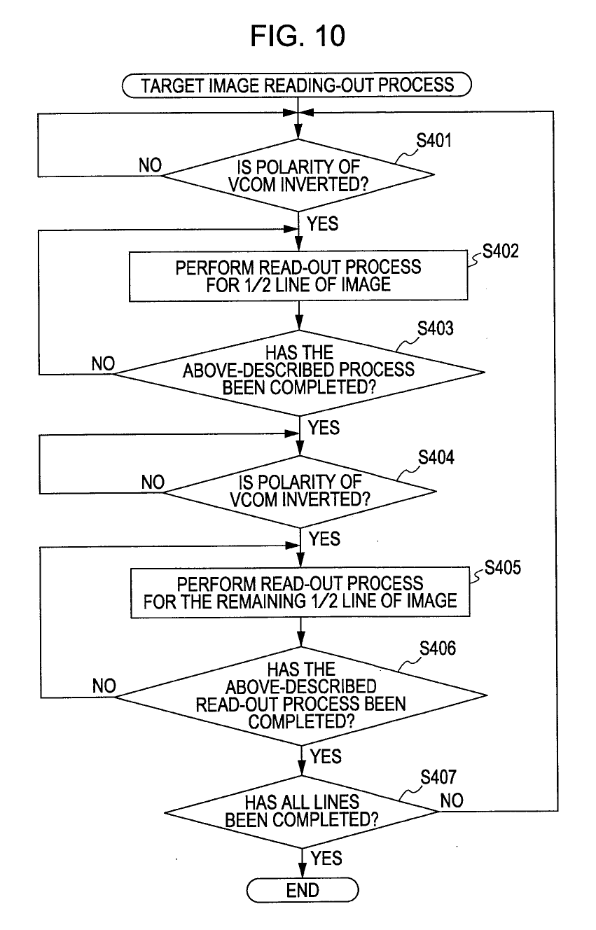

On the basis of the above-described configuration, the second embodiment has special aspects relating to the content of the target image reading-out process (Step S201 shown in FIG. 5) shown in FIG. 5. Such a process is performed as shown in FIG. 10.

First, the control circuit C determines whether there is inversion of the polarity of the common electric potential VCOM (Step S401 shown in FIG. 10). The meaning of the determination is the same as that of the above-described Step S301 shown in FIG. 7.

Next, when there is the inversion of the polarity of the common electric potential VCOM (Step S401 shown in FIG. 10; YES), the image reading-out process for a half line is performed (Step S402 shown in FIG. 10). Here, the “image reading-out process for a half line”, as is apparent from the description made with reference to FIG. 9, means that acquisition of the light amount data originated from the light amount detecting elements 50-1, 2, . . . , 60 is performed.

In addition, acquisition of the light amount data is performed at a time other than the inversion time, and Steps S402 and S403 shown in FIG. 10 are processes that are performed integrally or simultaneously in a parallel manner in the same meaning for Steps S302 and S303 shown in FIG. 7, which are the same as those of the first embodiment (this point is also the same for Steps S405 and S406 shown in FIG. 10 to be described right below).

Next, when the “image reading-out process for a half line” is completed, the control circuit C determines whether there is inversion of the polarity of the common electric potential VCOM again (Step S404 shown in FIG. 10). When the result of the determination is positive, an image reading-out process for the “remaining” half line is performed (Step S405 shown in FIG. 10). Here, the image reading-out process for the “remaining” half line means that the light amount data originated from the light amount detecting elements 50-61, 62 . . . 120 is acquired.

The above-described process is repeatedly performed until the image reading-out process for all the lines is completed (Step S407 shown in FIG. 10).

By performing the above-described process, the following advantages can be acquired in the second embodiment.

First, also in this second embodiment, the read-out of the target image is performed at a time other than the inversion time, which is not changed at all from the first embodiment. Accordingly, it is apparent that advantages that are not essentially different from those of the first embodiment are acquired. In other words, also in the second embodiment, the possibility that the disturbance or the like of the image occurs is decreased much, and detection of the contact position of the object is performed with high accuracy.

Additionally, particularly in the second embodiment, the following advantages are acquired, as well.

First, in the above-described process of Step S402 or S405 shown in FIG. 10, basically same as in FIG. 3 although there is a difference in the “half line”, read-out of the sensor driving signals for the i-th row and, the (i+1)-th row, and the like and read-out of the light amount data of the light amount detecting elements 50 located in the i-th row, the (i+1)-th row, and the like, which is triggered by the above-described sensor driving signals, are performed.

The waveform of the read-out signal shown in FIG. 3 is drawn as an ideal type. In such a case, although whether the read-out light amount data is sufficiently reliable matters scarcely, the waveform (or the light amount data) reflects the actual state (for example, the state as shown in FIG. 6) accurately in a short time, and basically a constant value is returned regardless of a time taken between the inversion times of K1 and K2.

However, a more practical read-out waveform of the light amount data, as shown in FIG. 11, may be gradually increased in accordance with the elapse of a time from a time point of start of read-out. This occurs since the sensor signal line 60 or the external signal line 60A has parasitic capacitance and the like therein. When such a practical waveform is applied to the case shown in FIG. 3, there is a problem that the light amount data not reflecting the actual state accurately may be acquired. The reason is that the electric potential of the sensor signal line 60 or the like may be increased, for example, only up to a point A as shown in FIG. 11 within a relatively limited time between the inversion times of K1 and K2.

Such a problem becomes serious as the matrix-shaped array that is followed by the array of the light amount detecting elements 50 becomes larger. The reason is that, in such a case, there is a high possibility that the length of the sensor signal line 60 is increased.

According to the second embodiment, such a problem is overcome well. The reason is that the absolute amount of the light amount data to be acquired in one chance during a relatively short period determined in advance, that is, a period between the inversion times of K3 and K4 shown in FIG. 11 is limited in advance. Here, it is apparent that the “limit” means the above-described “a half line”. In other words, according to the second embodiment, acquisition of the light amount data in the above-described chance is performed only for a half of the light amount detecting elements 50 located in any row. Accordingly, the electric potentials of the sensor signal lines 60 and the like can reach a sufficiently stable state even within such a relatively short period. Therefore, a possibility that more accurate light amount data can be acquired becomes high (see a reference sign “Z” shown in FIG. 11). These advantages can be recognized more clearly when a case where acquisition of the light amount data for all the light amount detecting elements 50 and the process for all the light amount detecting elements 50 are performed altogether at the same time is considered.

As described above, according to the second embodiment, it is possible to acquire accurate light amount data on which the actual state is reflected well.

In addition, the number of the light amount detecting elements 50 and the number of the multiplexers 610 that are shown in FIG. 9 merely show examples.

In addition, the configuration for reading out the light amount data that is shown in FIG. 9 merely shows an example. As a concrete circuit diagram for reading out the light amount data from a plurality of the light amount detecting elements 50 in an ordered form (for example, a state in which a light amount detecting element 50 corresponding to specific light amount data can be acquired well or the like) in a relatively speedy manner, various configurations other than the above-described configuration may be considered. According to an embodiment of the invention, such configurations can be basically employed regardless of the types of the configurations.

In addition, in the above description, the two inversion time periods that are temporally adjacent to each other are used. Then, the former image reading-out process is performed for a half line, and the latter image reading-out process is performed for the remaining half line. However, the invention is not limited thereto.

For example, four inversion times L1, L2, L3, and L4 that are temporally adjacent to each other in time points may be used. In such a case, an image reading-out process is performed for one third line between L1 and L2, an image reading-out process is performed for the next one third line between L2 and L3, and an image reading-out process is performed for the remaining one third line between L3 and L4.

### Third Embodiment

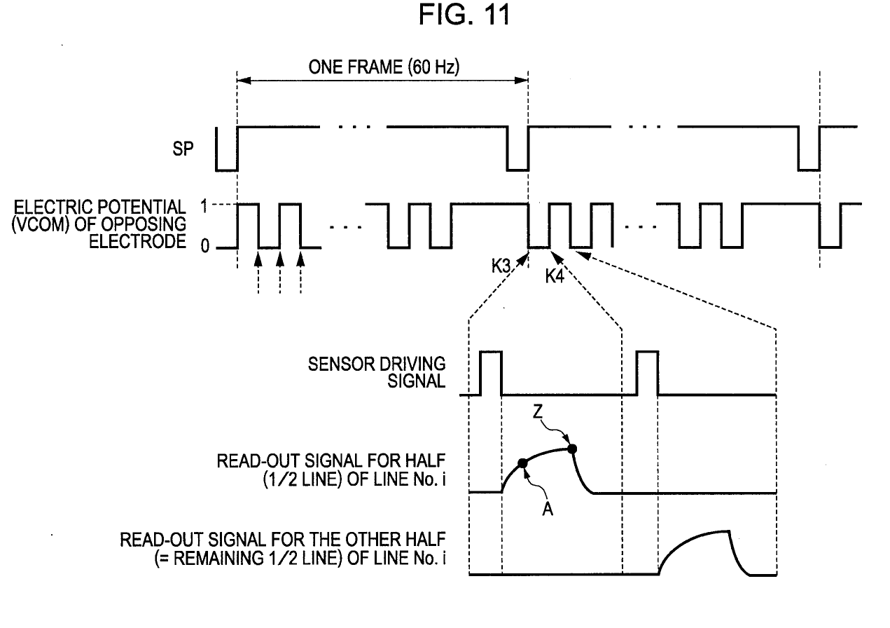

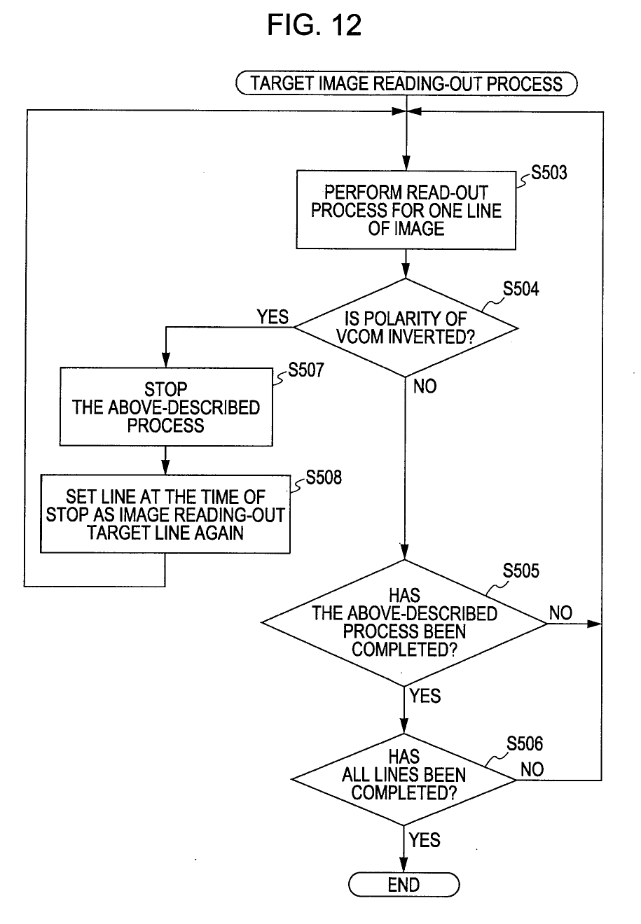

Hereinafter, a third embodiment of the invention will be described with reference to FIG. 12. The configuration of an electro-optical device 1, the content of the basic process relating to the process for detecting the position of an object, and the like according to the third embodiment are the same as those according to the first embodiment. Thus, the description of a duplicate portion will be simplified or omitted appropriately.

The third embodiment has special aspects relating to the content of the target image reading-out process (Step S201 shown in FIG. 5) shown in FIG. 5. Such a process is performed as shown in FIG. 12.

First, the control circuit C, differently from the above-described first and second embodiments, starts the image reading-out process for one line (S503 shown in FIG. 12). In this point, the third embodiment is different from both the above-described first and second embodiments in which, first, whether there is inversion of the polarity of the common electric potential VCOM is determined (Step S301 shown in FIG. 7 or Step S401 shown in FIG. 10).

Subsequently, the control circuit C determines whether there is inversion of the polarity of the common electric potential VCOM integrally or in parallel with the above-described process (Step S504 shown in FIG. 12). When the result of the determination is negative (Step S504 shown in FIG. 12; NO), the control circuit C monitors whether read-out for all the light amount detecting elements 50 located in the i-th row is completed (Step S505 shown in FIG. 12). The processing relationship relating to these steps is the same as that of Steps S302 and S303 shown in FIG. 7, Steps S405 and S406 shown in FIG. 10, or the like.

When the inversion of the polarity of the common electric potential VCOM occurs in the middle of such a process (Step S504 shown in FIG. 12; YES), the image reading-out process for one line that is actually performed at that time point is stopped (Step S507 shown in FIG. 12). Then, the control circuit C sets a line of the i-th row that is the target for image reading-out at the time point of stopping as the target line for image reading-out again (Step S508 shown in FIG. 12), and then performs the image reading-out process for the line of the i-th row as one line (Step S503 shown in FIG. 12). In other words, according to the third embodiment, the light amount data for the i-th row is newly acquired so as to be corrected. Then, not so long as the inversion of the common electric potential VCOM occurs during a period in which the light amount data is acquired again (see Step S504 shown in FIG. 12), the light amount data for the i-th row is successfully acquired at a time other than the time point of the inversion time.

As is apparent from the descriptions above, the “measurement area” according to an embodiment of the invention is defined by using the “light amount detecting element 50 that is connected to one sensor scanning line 30” according to the third embodiment as one unit. Described briefly, one “measurement area” is so to speak an area corresponding to one line.

By performing the above-described processes, the following advantages are acquired in the third embodiment.

In other words, according to the third embodiment, read-out of the target image is not performed by avoiding the inversion time. On the contrary, according to the third embodiment, reach of a time point of the inversion time during the image reading-out process is in a state in which inclusion of the inversion time is completed.

However, according to the third embodiment, the light amount data acquired at such a time point is not directly used for performing the object position detecting process (Step S203 shown in FIG. 5). The reason is that, as is apparent from the description for the processes of Steps S507 and S508 shown in FIG. 12, the light amount data acquired at such a time point is configured to be abolished or ignored. According to the third embodiment, instead of using the above-described light amount data, the image reading-out process for one line that has such a defection is performed again, and new light amount data that is acquired by the image reading-out process is supplied to the object position detecting process.

As can be known from the description above, according to the third embodiment, it is apparent that advantages that are not essentially different from those according to the first embodiment are also acquired as a result. In other words, according to the third embodiment, the possibility that disturbance of an image occurs is decreased much, and detection of the contact position of an object can be performed with high accuracy.

In addition, in the description above, when the inversion time is reached in the middle of the image reading-out process for one line, the image reading-out process (see Step S508 shown in FIG. 12) for the same line is performed again. However, in some cases, the image reading-out process that is performed again may be omitted. Even when there is loss of information on the target image for one line, the accuracy of detection of the position of an object may not be particularly affected. The processing flow for such a case, for example, in FIG. 12, a case where the process directly proceeds to Step S506 from Step S507 can be considered. Accordingly, in such a case, simplification of the target image acquiring process that is performed in a speedy manner can be realized.

Above all, it is apparent that the above-described third embodiment is superior to this form in terms of the degree of accuracy of detection of the position of an object.

### MODIFIED EXAMPLES

As above, the embodiments of the invention have been described. However, the electro-optical device according to an embodiment of the invention is not limited thereto, and various modifications may be made therein.
(1) In each of the above-described embodiments, for example, like a time between the inversion times K1 and K2 shown in FIG. 3, an example in which the target image is read out or the light amount data is acquired by using the time between consecutive inversion times only (the above-described first and second embodiments) or mainly (the above-described third embodiment) has been described. However, the invention is not limited thereto.

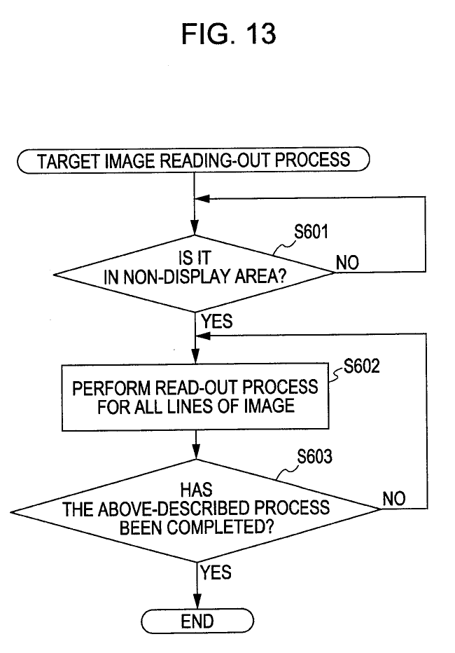

For example, as shown in FIG. 13, in the case where an area (hereinafter, referred to as a “non-display area”) in which an image is not displayed is included in the portion of the image displaying surface 7a, the target image reading-out process may be configured to be performed at a time (hereinafter, referred to as “at a non-display time”) when the liquid crystal element 8 corresponding to the non-display area is driven (see the flow from Step S601 to S602 shown in FIG. 13). In the non-display area, the liquid crystal element 8 does not need to be driven substantially. Thus, normally, the polarity inversion driving shown in FIG. 3 and the like is not performed (in other words, the common electric potential VCOM is maintained to be 0 or 1 instantly). Accordingly, even performing such a process, the light amount data can be acquired by avoiding the inversion time.

In addition, according to an embodiment combining the above-described form and each of the above-described embodiments, the light amount data acquiring process is performed not only at a time such as a time between the inversion times but also at the non-display time. Accordingly, an advantage that all the measurement results (for example, light amount data for one screen) of light amount data needed for detection of the position of an object can be acquired and processed in a more speedy manner can be acquired.

In addition, according to such a modified example, normally, acquisition of light amount data for the entire image displaying surface 7a is not necessary as long as the non-display area exists. Such a case may be regarded as an example for a case where “the predetermined physical amount for a part of the image displaying surface is measured” according to an embodiment of the invention. However, the phrase of measuring “the predetermined physical amount for a part” described here may include measurement of “a part” for a case where detection of the position of an object needs to be performed only for a limited area of the image displaying surface 7a although an image is displayed on the entire image displaying surface 7a (that is, the non-display area does not exist).
(2) In each of the above-described embodiments, acquisition of the light amount data by using the light amount detecting element 50 and detection of the position of an object on the basis of the acquisition of the light amount data are performed. However, the invention is not limited thereto.

As a type (that is, a type for implementing a touch panel) for detecting the position of an object that is brought into contact with the image displaying surface 7a, there are various types such as an electrostatic capacitance type, a SAW (surface acoustic wave) type, an electromagnetic induction type, and a light detecting type. Among these, for example, in the electrostatic capacitance type, the change in electric charges accumulated in capacitors that are arranged, for example, in the matrix shape within the image displaying surface occurs based on whether an object is brought into contact with the image displaying surface (the capacitors may have a concrete form such as a form including a structure in which two island-shaped electrodes face each other or a form that is built by a portion in which two long electrodes intersect each other). Thus, in such a case, for example, “a current amount on the basis of the electric charge that is accumulated in the capacitors and are discharged from the capacitors or the like corresponds to the “physical amount” according to an embodiment of the invention. In addition, in each of the above-described embodiments, it is apparent that the “physical amount” includes the “light amount”.

As described above, basically, the invention is not limited to the type for detecting the position of an object.
(3) In each of the above-described embodiments, as an example of the polarity inversion driving, only so-called line inversion driving has been described. However, the invention is not limited thereto.

The invention can be apparently applied to frame inversion driving in which one frame period is used as a reference for a period of polarity inversion.

In addition, the invention can be applied to dot inversion driving in which, in short, polarity inversion is performed by using one liquid crystal element 8 such as 1×1 of the liquid crystal element, or 1×1 of the above-described pixel (one set of the liquid crystal elements 8R, 8G, and 8B shown in FIG. 2 or 8), or 1×1 unitary configuration (that is, twelve liquid crystal elements 8) described with reference to FIG. 8 in some cases, as a base reference.
(4) In each of the above-described embodiments, the arrangement form of the light amount detecting elements 50 merely shows an example. For example, as an extreme example, one light amount detecting element 50 may be configured to be arranged for one liquid crystal element 8. In addition, the light amount detecting elements 50 do not necessarily need to be aligned along the matrix-shaped array on the whole.
(5) In each of the above-described embodiments, in order to acquire the difference data, calculation of “reference image−target image” is performed simply (see FIG. 5). However the invention is not limited thereto. For example, it is more preferable that the following process is performed.

First, as reference images, two types of “reference image(0)” and “reference image(1)” corresponding to both cases where the common electric potential VCOM is “0” and the common electric potential VCOM is “1” are acquired (See FIG. 4). Second, the target image acquired in Step S201 shown in FIG. 5 or the light amount data is determined whether it is acquired at a time when the common electric potential VCOM is “0” or “1” (See FIG. 3 and the like). Then, third, in the process relating to Step S202 shown in FIG. 5, the “reference image (0)” is used as a reference for a case where the light amount data acquired at the time when the common electric potential VCOM=0 is used in calculation, and the “reference image (1)” is used as a reference for a case where the light amount data acquired at the time when the common electric potential VCOM=1 is used in calculation. In other words, when the former light amount data and the latter light amount data are referred to as “target image(0)” and “target image(1)”, “reference image(0)−target image(0)” is calculated for the former case, and “reference image(1)−target image(1)” is calculated for the latter case, whereby the difference data is acquired.

When such a process is performed, the position of an object can be detected with higher accuracy by considering different influence of the common electric potential VCOM on the light amount configuring an image depending on a level difference of the common electric potential VCOM. For example, in a case where only the above-described “reference image(0)” is prepared in advance, and the difference data is acquired by using only the “reference image(0)” (in other words, the difference data even for the target image(1) at the time when the common electric potential VCOM=1 is acquired by “reference image(0)−target image(1)”, there is a problem that the shadow SW shown in FIG. 6 or the like may not be extracted well.

The above-described step for preparing two types of the reference image (0) and the reference image (1) has implications that the acquisition conditions or background information for the target image and the reference image are unified, and accordingly, such a problem can be avoided very appropriately.
(6) In the above-described first and second embodiments, start of the read-out process for the target image depends on the inversion of the common electric potential VCOM (see Step S301 shown in FIG. 7 and Steps S401 and S404 shown in FIG. 10). In such a case, the polarity inversion driving is performed by the control circuit C, and accordingly; it can be basically stated that “whether the polarity of the common electric potential VCOM is inverted” can be determined by checking whether a direction relating to the polarity inversion is issued by the control circuit C. In other words, the issuing time of the direction may be regarded as the “inversion time”.

However, practically, when an electrode is set to a predetermined electric potential, the influence of parasitic capacitance included in the electrode as described in the above-described second embodiment needs to be considered. In other words, also in the inversion of the common electric potential VCOM, it is a rare case where an instant response as shown on the second level from the upper side in FIG. 3 can be expected. On the contrary, there is a high possibility that a phenomenon of occurrence of a gentle increase or decrease in the electric potential as described with reference to FIG. 11, that is, a phenomenon of repeating gentle inversion occurs. Particularly, as described above, the opposing electrode 5 is an electrode that has a relatively wide area so as to cover the area for forming all the pixel electrodes 13. Thus, the parasitic capacitance included in the opposing electrode 5 is much larger than that included in the sensor signal line 60 or the like, which is the premise of FIG. 11. Accordingly, it can be stated that the possibility that the above-described problem occurs becomes higher. In such a case, the possibility that the light amount data on the basis of the state in the middle of inversion is acquired, that is, a possibility that light amount data having constant incorrectness is acquired is increased.

Thus, in the above-described first and second embodiments, it is more preferable to replace the determination on “whether the polarity of the common electric potential VCOM is inverted” with determination on “whether the electric potential after inversion of the common electric potential VCOM is stabilized”. In such a case, the issuing time of the direction issued by the control circuit C cannot be regarded the same as the “inversion time”. Accordingly, for example, it may be configured that the common electric potential detecting circuit that monitors the electric potential of the opposing electrode 5 is newly arranged, and the control circuit C performs the above-described determination by referring to the output result of the common electric potential detecting circuit.

In such a form, the above-described various advantages can be acquired effectively.

In addition, according to the above-described third embodiment, the process for reading out the target image is performed regardless of existence of the polarity inversion (see FIG. 12), and thus, the description as above is not basically matched. In addition, when the inversion of the common electric potential VCOM is started, it is rather preferable that the process is stopped (see Step S507 shown in FIG. 12). According to the third embodiment, it is preferable that the concept of the issuing time of the direction relating to the polarity inversion=“inversion time” is followed.

However, also in the third embodiment, the above-described concept may be applied to the determination process in Step S504 shown in FIG. 12, and the invention is not intended to aggressively exclude such a case (according to the third embodiment, although any concept is taken, the stopped image reading-out process is performed again, and accordingly, it can be state that there is no big difference).
(7) In the above-described second embodiment, the image reading-out process for the half line is performed by using a period between two inversion times that are temporally adjacent to each other. However, the basic idea of the second embodiment is not necessarily departed from that of the above-described third embodiment. For example, the process in which the image reading-out process is performed regardless of existence of the polarity inversion in the ordinary state, same as in the third embodiment, and the image reading-out process for the half line is basically performed in one period between inversion times can be performed.

In such meaning, the above-described second and third embodiments can be implemented together. In addition, in the same meaning, the first and third embodiments can be implemented together.

### APPLIED EXAMPLES

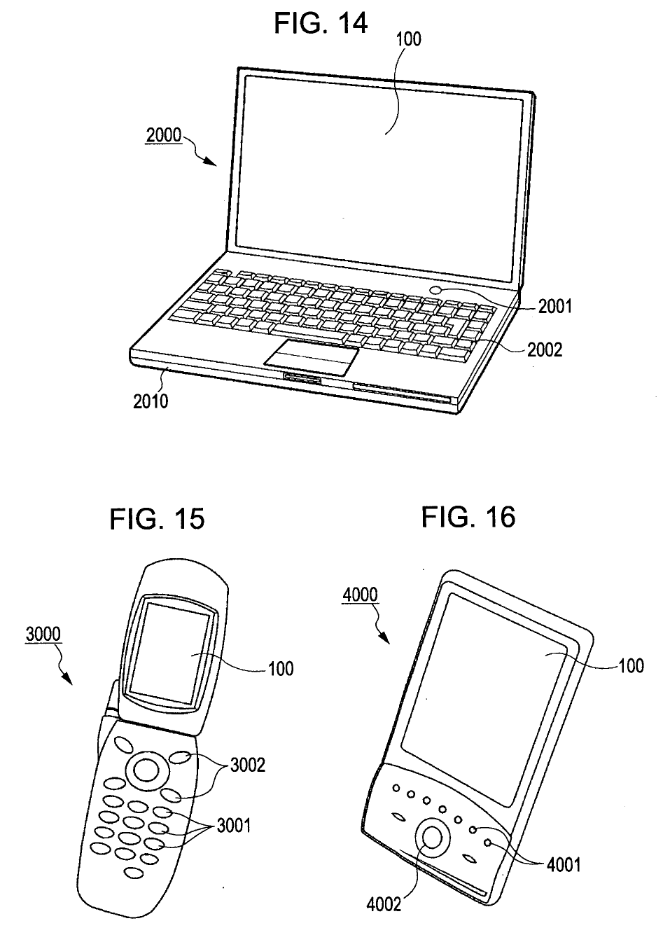

Next, an electronic apparatus that uses an electro-optical device according to an embodiment of the invention will be described. In FIGS. 14 to 16, the form of the electronic apparatus that uses a liquid crystal display device according to the above-described embodiment is shown.

FIG. 14 is a perspective view showing the configuration of a mobile-type personal computer that uses the liquid crystal display device. The personal computer 2000 includes a liquid crystal display device 100 that displays various images and a main body unit 2010 in which a power switch 2001 and a keyboard 2002 are installed.

FIG. 15 is a perspective view showing the configuration of a cellular phone using the liquid crystal display device 100. The cellular phone 3000 includes a plurality of operation buttons 3001, scroll buttons 3002, and the liquid crystal display device 100 that displays various images. By operating the scroll buttons 3002, the screen displayed in the liquid crystal display device 100 is scrolled.

FIG. 16 is a perspective view showing the configuration of a personal digital assistant (PDA) that uses the liquid crystal display device 100. The personal digital assistant 4000 includes a plurality of operation buttons 4001, a power switch 4002, and the liquid crystal display device 100 that displays various images. When the plurality of operation buttons 4001 is operated, various types of information such as an address book or a date book is displayed in the liquid crystal display device 100.

As electronic apparatuses to which the electro-optical device according to an embodiment of the invention is applied; a digital still camera, a television set, a video camera, a pager, an electronic organizer, an electronic paper, a calculator, a word processor, a workstation, a video phone, a POS terminal, a printer, a scanner, a copier, a video player, an apparatus having a touch panel, and the like, in addition to the apparatuses exemplified in FIGS. 14 to 16.

The entire disclosure of Japanese Patent Application No. 2008-213636, filed Aug. 22, 2008 is expressly incorporated by reference herein.

What is claimed is:

1. An electro-optical device comprising:
an electro-optical element that includes a first electrode, a second electrode, and an electro-optical material pinched by the first and second electrodes of which the optical characteristic is changed in accordance with supply of a predetermined electric potential;
a position detecting unit that detects a position of an object, which is brought into contact with an image displaying surface that displays an image configured by the electro-optical element, on the image displaying surface; and
a physical amount measuring unit that is included in the position detecting unit and measures a predetermined physical amount of the whole or a part of the image displaying surface for a case where the object is brought into contact with the image displaying surface;
wherein the position detecting unit detects the position of the object on the image displaying surface based on the measurement result of the physical amount measured by the physical amount measuring unit and based on the measurement result from which the measurement result measured by the physical amount measuring unit at an inversion time of the polarity of an electric potential difference between the first electrode and the second electrode is excluded.

2. The electro-optical device according to claim 1, wherein the physical amount measuring unit measures the physical amount only between two inversion times that are temporally adjacent to each other.

3. The electro-optical device according to claim 1,
wherein the physical amount measuring unit measures the physical amount between two inversion times that are temporally adjacent to each other and at the two inversion times, and
wherein the position detecting unit detects the position of the object on the image displaying surface by ignoring the measurement result measured at the two inversion times by the physical amount measuring unit.

4. The electro-optical device according to claim 3,
wherein the physical amount measuring unit measures the physical amount for each one of a plurality of measurement areas that partitions the physical displaying surface, and
wherein the physical amount measuring unit measures the physical amount at a time other than the inversion times for the measurement area corresponding to the physical amount that is detected at the inversion time, again.

5. The electro-optical device according to claim 1,
wherein a plurality of the electro-optical elements exists and is aligned along a matrix-shaped array,
wherein the physical amount measuring unit includes a plurality of physical amount measuring elements corresponding to a predetermined number of the electro-optical elements and signal lines that are used for reading out the measurement results of the physical amount measuring elements, and
wherein the reading-out of the physical amounts by using the signal lines is performed for “1/(n−1)” physical amount measuring elements among the physical amount measuring elements corresponding to a specific row of the matrix-shaped array after the m-th inversion time (here, m 1, 2, . . . , n−1) among n inversion times (here, n is a positive integer) that are temporally continuous.

6. The electro-optical device according to claim 1, wherein, in a case where an area in which the image is not displayed is included in a portion of the image displaying surface, the physical amount measuring unit measures the physical amount at a time when the electro-optical element corresponding to the area is driven.

7. The electro-optical device according to claim 1,
wherein at least one between the first electrode and the second electrode is aligned along a matrix-shaped array, and
wherein the inversion of the polarity of the electric potential is performed by using a row or a column of the matrix-shaped array as one unit.

8. An electronic apparatus comprising the electro-optical device according to claim 1.

9. A method of detecting the position of a directing object for detecting the position of the object, which directs a spot on an image displaying surface displaying an image, on the image displaying surface, the method comprising:
applying a predetermined electric potential difference between a first electrode and a second electrode for changing the optical characteristics of an electro-optical material that is pinched between the first and second electrodes that configure an electro-optical element forming the image;
measuring a predetermined physical amount of the whole or a part of the image displaying surface for a case where the object is brought into contact with the image displaying surface; and
detecting the position of the object, which is brought into contact with the image displaying surface, on the image displaying surface based on the measurement result of the physical amount in the measuring of the predetermined physical amount,
wherein the applying of the predetermined electric potential difference includes inverting the polarity of the electric potential difference between the first electrode and the second electrode, and
wherein the detecting of the position of the object includes detecting the position of the object on the image displaying surface based on the measurement result from which the measurement result measured at an inversion time of the polarity by the physical amount measuring unit.

10. The method according to claim 9, wherein the measuring of the predetermined physical amount includes measuring the physical amount only between two inversion times that are temporally adjacent to each other.

11. The method according to claim 9,
wherein the measuring of the predetermined physical amount includes measuring the physical amount between two inversion times that are temporally adjacent to each other and at the two inversion times, and
wherein, in the detecting of the position of the object, the position of the object on the image displaying surface is detected by ignoring the measurement result measured at the two inversion times by the physical amount measuring unit.

12. The method according to claim 11,
wherein the measuring of the predetermined physical amount includes measuring the physical amount for each one of a plurality of measurement areas that partitions the image displaying surface, and
wherein the measuring of the predetermined physical amount includes measuring the physical amount at a time other than the inversion times for the measurement area corresponding to the physical amount that is detected at the inversion time, again.

13. The method according to claim 9,
wherein a plurality of the electro-optical elements exists and is aligned along a matrix-shaped array,
wherein the measuring of the physical amount is performed by using a plurality of physical amount measuring elements corresponding to a predetermined number of the electro-optical elements and signal lines that are used for reading out the measurement results measured by the physical amount measuring elements, and
wherein the reading-out of the physical amounts by using the signal lines is performed for “1/(n−1)” physical amount measuring elements among the physical amount measuring elements corresponding to a specific row of the matrix-shaped array after the m-th inversion time (here, m=1, 2, . . . , n−1) among n inversion times (here, n is a positive integer) that are temporally continuous.

14. The method according to claim 9, wherein, in a case where an area in which the image is not displayed is included in a portion of the image displaying surface, the measuring of the predetermined physical amount is performed at a time when the electro-optical element corresponding to the area is driven.

15. The method according to claim 9,
wherein at least one between the first electrode and the second electrode is aligned along a matrix-shaped array, and
wherein the inverting of the polarity of the electric potential is performed by using a row or a column of the matrix-shaped array as one unit.
